(19) United States
(12) Patent Application Publication
(10) Pub. No.: US 2007/0157975 A1
(43) Pub. Date: Jul. 12, 2007

(54) Generator of liquid media distribution pattern

(76) Inventor: Andrei Alexandrovich Malayev, San Diego, CA (US)

Correspondence Address: Andrew Malayev, 4527 52nd Street, San Diego, CA, 92115, US

(21) Appl. No.: 11/332,671

(22) Filed: Jan. 12, 2006

(51) Int. Cl. F16K 11/00

(52) U.S. Cl. 137/597

(57) ABSTRACT

A device for containing liquid media without complete mixing with each other comprises a container (3) with inlet (4, 5) and outlet (6, 7) ports, FIG. 1. Different media is supplied through inlet ports (4, 5) into predetermined areas (8, 9) inside container (3), FIG. 2. Some media mix with each other and form interface (10) between areas (8, 9). Mixed media is continuously removed from interface (10) through outlet ports (6, 7). This continuous media supply and removal of mixed media results in media distribution pattern where areas (8, 9) contain only supplied unmixed media.

### BACKGROUND—PRIOR ART

In many applications involving introduction of a soluble compound inside a container filled with liquid medium, the compound starts diffusing from the point of introduction towards surrounding areas and eventually reaches every point within the container. This diffusion, if given sufficient period of time, effectively contaminates the medium inside all regions of the container. Similar mechanisms ale also responsible for mixing of different liquid media inside the same container. After introduction inside the container, liquid media will mix with each other, even without help of stirring.

### OBJECTS AND ADVANTAGES

Accordingly, the object and advantages of my invention are to provide a method of liquid media handling, which generates stable distribution of at least two different media inside a container with predetermined areas containing only the required medium.

Still further objects and advantages will become apparent from a consideration of the ensuing description and accompanying drawings.

### SUMMARY

A method of generating stable distribution of different liquid media comprises a container with a plurality of inlet and outlet ports, continuous predetermined supply of liquid media through inlet ports, and continuous predetermined removal of mixed media through outlet ports.

### DRAWINGS—FIGURES

FIG. 1 is a perspective view of Generator, showing a container with inlet ports for liquid media and outlet ports for removal of mixed media.

FIG. 2 is the top view of Generator, showing that the ports are disposed to provide liquid media supply into predetermined areas of the container and continuous removal of mixed media out of the container.

### DRAWINGS—REFERENCE NUMERALS

3 container

4 inlet port

5 inlet port

6 outlet port

7 outlet port

8 area containing medium supplied through port 4

9 area containing medium supplied through port 6

10 area containing mixed media

### DETAILED DESCRIPTION—PREFERRED EMBODIMENT

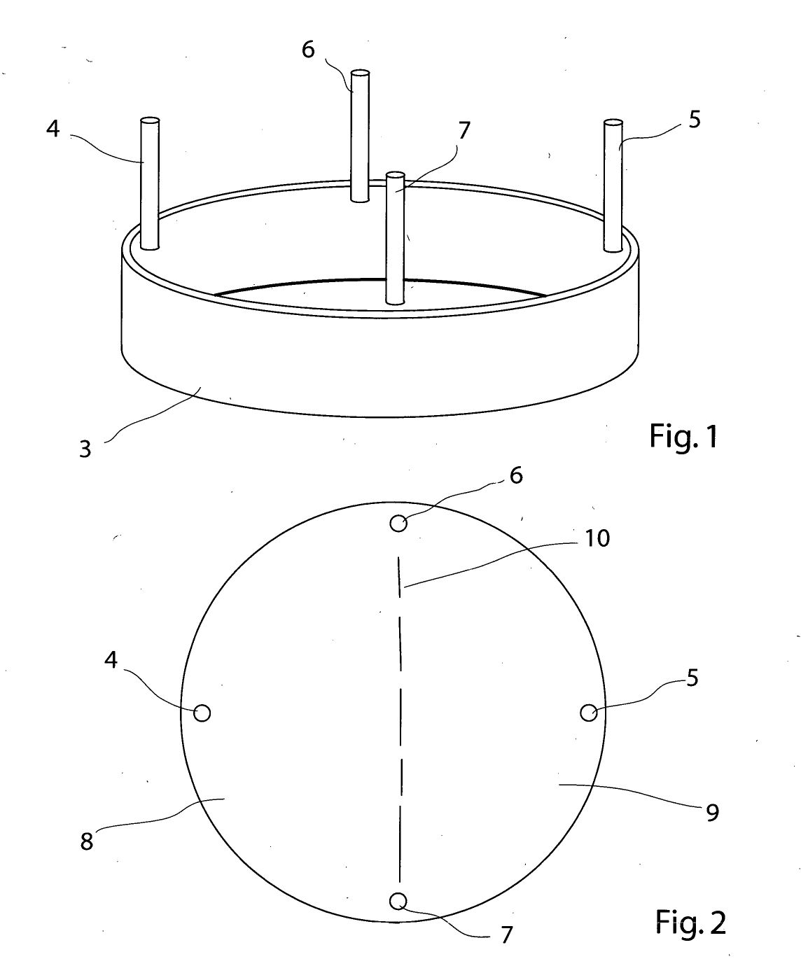

FIG. 1 shows container 3 with inlet 4, 5 and outlet 6, 7 ports for media supply and removal respectively.

FIG. 2 shows areas 8 and 9 containing media supplied through inlet ports 4 and 5 respectively. The media mix at interface 10 and removed from the container through outlet ports 6 and 7.

### OPERATION—FIG. 1, 2

Generator of Distribution Pattern for different liquid media effectively functions as follows: Different media are supplied inside container 3 through inlet ports 4 and 5. The container can be a hollow cylinder closed on the bottom, and ports can be pipes inserted and held inside the cylinder. The medium supply can be provided by a pump through tubing connected to a source of the medium and to the inlet ports. The media excess, including mixed media, is removed through outlet ports 6, 7. The outlet ports can also be pipes inserted and held inside the cylinder. The outflow can be provided by other set of pumps through tubing connected to the outlet ports. The media are continuously introduced through the inlet ports at the rate faster than diffusion and mixing rates of these media inside one another. Since diffusion and mixing are slower, the areas 8 and 9, which are adjacent to the inlet ports 4 and 5 respectively, contain only supplied unmixed media. The mixed media will form an interface 10, sandwiched between areas 8 and 9. Liquid in this mixed media interface is continuously removed from the container through outlet ports 6, 7. The mixing process depends on flow rates of supplied media and outflow rate of mixed media. The flow rates determine shape and sizes of areas 8 and 9 containing unmixed media and shape and width of interface 10 containing mixed media.

### ADVANTAGES

Complete mixing of different liquid media in predetermined areas 8 and 9 does not occur because of continuous controlled media supply inside these areas and continuous controlled removal of mixed media from the container.

### CONCLUSIONS, RAMIFICATIONS, AND SCOPE

Accordingly, the described system provides a new method of liquid media handling without complete mixing inside containers. This method provides stable media distribution pattern of areas containing only required media.

Although the description above contains many specificities, these should not be construed as limiting the scope of the invention but as merely providing illustrations of some of the presently preferred embodiments of this invention. Various other embodiments and ramifications are possible within it's scope. For example, the number of inlet and outlet ports can vary. The number of ports needs to be greater than two, for example, if more than two different media are handled inside the same container. Shape and size of inlet and outlet ports, positions of the ports inside containers and shape and size of the container can vary as well. The container, for example, can be completely covered on the top or can have a number of holes disposed along its boundaries.

Thus the scope of the invention should be determined by the appended claims and their legal equivalents, rather than by the examples given.

What is claimed is:

1. A method of liquid media handling without mixing inside containers comprising:
a) a container of predetermined shape and size with
b) a plurality of inlet ports of predetermined shape and size, and with
c) a plurality of outlet ports of predetermined shape and size
d) means of providing flow of media through said inlet and outlet ports
e) means of controlling flow rates through said ports so that mixed media are removed from predetermined areas of said container and fresh media are supplied into predetermined areas of said container at flow rates faster than media mixing rate

2. The method of claim 1 wherein said flow rates are manipulated so that shapes and sizes of said predetermined areas are changing in time at predetermined rate.
